(19) United States
(12) Patent Application Publication
(10) Pub. No.: US 2014/0074309 A1
(43) Pub. Date: Mar. 13, 2014

(54) POWER USAGE CONTROL SYSTEM

(71) Applicants: Rong-Ching Wu, Kaohsiung (TW); Chun-Wei Tseng, Kaohsiung (TW); Chun-Hui Ho, Kaohsiung (TW); Chiung-Chang Hsieh, Hsinchu (TW)

(72) Inventors: Rong-Ching Wu, Kaohsiung (TW); Chun-Wei Tseng, Kaohsiung (TW); Chun-Hui Ho, Kaohsiung (TW); Chiung-Chang Hsieh, Hsinchu (TW)

(21) Appl. No.: 13/608,859

(22) Filed: Sep. 10, 2012

(51) Int. Cl. G06F 1/26

(52) U.S. Cl. 700/297

(57) ABSTRACT

A power usage control system includes a transmission medium for transmitting power. A management module is coupled to the transmission medium. A control module is coupled to the transmission medium and at least one controlled apparatus. The management module and the control module communicate with each other through the transmission medium. The management module monitors an operation status of the at least one controlled apparatus through the control module. The management module controls the at least one controlled apparatus through the control module.

### BACKGROUND OF THE INVENTION

1. Field of the Invention

The present invention relates to a power usage control system and, more particularly, to a power usage control system for monitoring/controlling power usage and user needs in a building.

2. Description of the Related Art

The power usage in industries and livelihood is significantly increased due to an increase in the living condition and global warming. However, the development of energy faces difficulties because of the fluctuation of energy prices and the increased environmental protection awareness, leading to gradual increase in the electricity costs.

According to the statistics by the Ministry of Economic Affairs of R.O.C., the power usage of household and business buildings is 34% of total power usage, which is only lower than the power usage of industries that is 50% of the total power usage. More than 52% of the power usage of old buildings (such as apartments) is used in illumination and air conditioning. Furthermore, 7.4% of the average power usage in each family is consumed in standby status.

Thus, it is an imminent issue to reduce the energy consumption by appropriately saving energy while fulfilling the needs (such as illumination, air conditioning, etc.) of the users in the buildings. Many useful remote load-management methods have been developed to manage the power usage of loads, such as intelligent kilowatt-hour meters, intelligent power grids, and intelligent illumination control apparatuses, for connecting the power systems to networks for the purposes of monitoring/controlling power.

FIG. 1 shows a conventional power control device for real-time display of system power usage. Specifically, the power control device 9 includes a power line 91 for transmitting power, an electromagnetic induction unit 92 surrounding the power line 91, a processing unit 93 electrically connected to the electromagnetic induction unit 92, and a display unit 94 electrically connected to the processing unit 93. The processing unit 93 includes a rectifier/filter circuit 931, an amplifying circuit 932, and a conversion/comparison circuit 933. The electromagnetic induction unit 92 senses a change of the current in the power line 91, and the processing unit 93 produces a power usage signal indicative of the change of the current. The display unit 94 displays power usage information according to the power usage signal. A user can adjust the power usage based on the power usage information. An example of such a power control system is disclosed in Taiwan Patent Publication No. 200918905.

However, the power control device 9 can merely display the power usage information, and the user has to manually adjust the power usage. The power control device 9 can not be automatically controlled by using the power usage information for the purposes of monitoring/controlling power usage. Improvement to the power control device 9 is needed in an environment requiring manpower saving and management of power usage of loads.

Thus, a need exists for a power usage control system for saving manpower and allowing management of power usage of loads and allowing automatic monitoring/controlling of the power usage, providing enhanced utility.

### SUMMARY OF THE INVENTION

An objective of the present invention is to provide a power usage control system to fulfill the above need by using a power line to monitor/control the power usage of loads, meeting the requirement of manpower saving and management of power usage of loads.

The power usage control system includes a transmission medium for transmitting power. A management module is coupled to the transmission medium. A control module is coupled to the transmission medium and at least one controlled apparatus. The management module and the control module communicate with each other through the transmission medium. The management module monitors an operation status of the at least one controlled apparatus through the control module. The management module controls the at least one controlled apparatus through the control module.

The transmission medium can be a power line.

The at least one controlled apparatus can be a wireless controlled apparatus or a wire controlled apparatus.

The management module includes a carrier unit, a measuring unit, a processing unit, an input unit, and an output unit. The carrier unit and the measuring unit are coupled to the transmission medium. The processing unit is electrically connected to the carrier unit, the measuring unit, the input unit, and the output unit.

The control module includes a first control module. The first control module includes a carrier unit, a processing unit, an input unit, a remote control unit, and an output unit. The carrier unit is coupled to the transmission medium. The processing unit is electrically connected to the carrier unit, the input unit, the remote control unit, and the output unit. The remote control unit is coupled to a first controlled apparatus of the at least one controlled apparatus.

The control module further includes a second control module. The second control module includes a carrier unit, a processing unit, an input unit, an electrical control unit, and an output unit. The carrier unit of the second control module is coupled to the transmission medium. The processing unit of the second control module is electrically connected to the carrier unit, the input unit, the electrical control unit, and the output unit of the second control module. The electrical control unit is coupled to a second controlled apparatus of the at least one controlled apparatus.

The first controlled apparatus can be an air conditioner, a television, a stereo, or a security apparatus.

The second controlled apparatus can be an illumination device, an electrical heating device, or a water pump.

The control module including a wire control module, with the wire control module including a carrier unit, a processing unit, an input unit, an electrical control unit, and an output unit, with the carrier unit of the wire control module coupled to the transmission medium, with the processing unit of the wire control module electrically connected to the carrier unit, the input unit, the electrical control unit, and the output unit of the wire control module, with the electrical control unit coupled to a wire controlled apparatus of the at least one controlled apparatus.

The wire controlled apparatus can be an illumination device, an electrical heating device, or a water pump.

The management module includes a management program, with the management program producing at least one control command to control the control module. The management program includes at least one operation threshold. The management program undergoes a load management procedure when an actual operation value of the at least one controlled apparatus is higher than the at least one operation threshold. The control command is sent to the control module to shut down a portion or all of the at least one controlled apparatus after an unloading time.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 shows a conventional power control device.

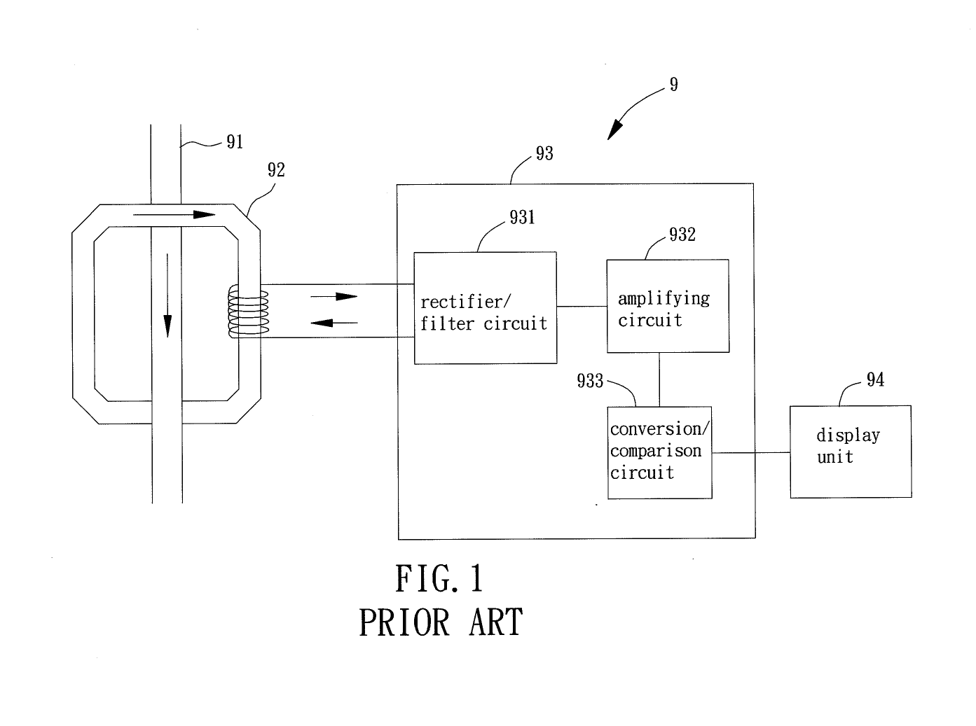

FIG. 2 shows a schematic diagram illustrating an embodiment of a power usage control system according to the present invention.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

The term “power line” referred to hereinafter means a power line used as a transmission medium for power and communication, such that the power line provides functions of power transmission and data communication for supplying power usage of loads and monitoring/controlling the power usage of loads, which can be appreciated by one having ordinary skilled in the art.

The term “coupling” referred to hereinafter means connection between two ends by a wire or wireless connection, such as a metal conductor or electromagnetic induction, allowing data communication between the ends, which can be appreciated by one having ordinary skill in the art.

The term “control command” referred to hereinafter means a command sent out by a management module to control a first control module or a second control module to activate the first or second control module to operate according to the command, which can be appreciated by one having ordinary skill in the art.

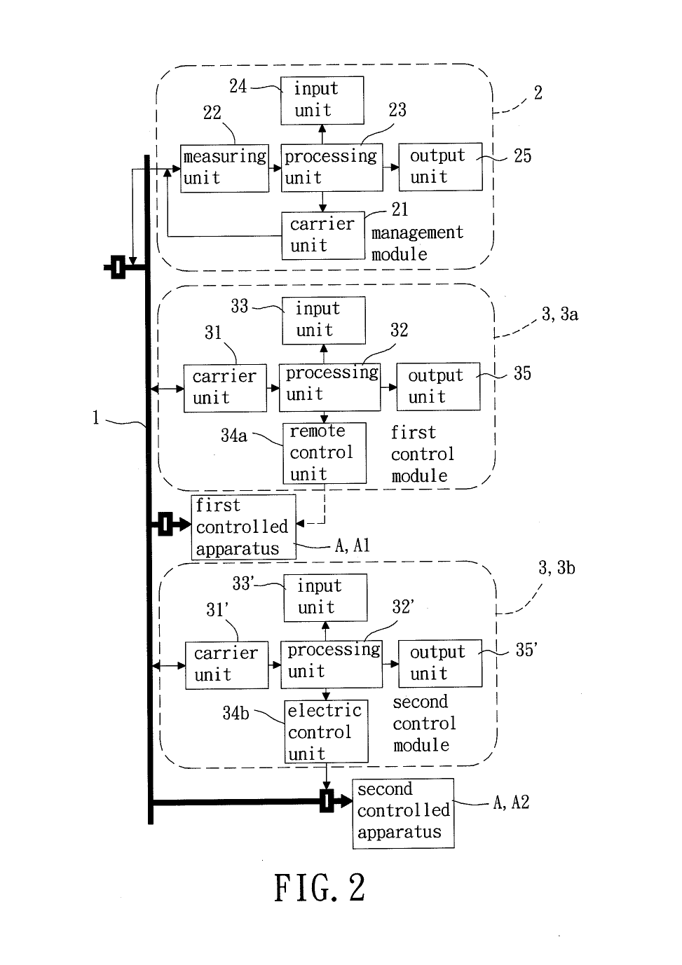

FIG. 2 shows an embodiment of a power usage control system according to the present invention. The power usage control system includes a transmission medium 1, a management module 2, and a control module 3. The transmission medium 1 is electrically connected to the management module 2 and the control module 3.

The transmission medium 1 is comprised of a power line communication (PLC) medium, such as a copper or silver power line, allowing a power system (not shown) to transmit power to the management module 2 and the control module 3. The transmission medium 1 also transmits communication data to allow mutual communication between the management module 2 and the control module 3. In this embodiment, the transmission medium 1 undergoes low-speed carrier communication by a carrier, including, but not limited to, signal transmission in a range of 100-400 kHz. Thus, the management module 2 and the control module 3 can receive and transmit a communication data carrier through the transmission medium 1, such as by using modulation/demodulation to proceed with data communication, which can be appreciated by one having ordinary skilled in the art.

The management module 2 includes circuits or devices for receiving and transmitting signals, measuring the signals, processing data, and input/output of the data. The management module 2 is coupled to the transmission medium 1 for monitoring an operation status of the control module 3, such as the status of switches, setting of temperature, etc. for the purposes of controlling the control module 3, such as turning on/off apparatuses using power or adjusting the set temperature. In this embodiment, the management module 2 includes a carrier unit 21, a measuring unit 22, a processing unit 23, an input unit 24, and an output unit 25. The carrier unit 21 and the measuring unit 22 are coupled to the transmission medium 1. The processing unit 23 is electrically connected to the carrier unit 21, the measuring unit 22, the input unit 24, and the output unit 25.

The carrier unit 21 can be a carrier transmission device, such as a conventional power line carrier data transmitter, for transmitting at least one control command to the transmission medium 1, and receiving the operation status following from the at least one control command from the transmission medium 1. The measuring unit 22 can be an electrical parameter capture device, such as a conventional current meter, a potential meter, or a signal capture/conversion circuit, for measuring at least one electrical parameter (such as power usage information including voltage, current, phase angle, active power, or reactive power) of a power grid. The measuring unit 22 converts the at least one electric parameter into a signal format required by the processing unit 23, such as converting a 155.5V of a power grid into a voltage having an amplitude of 2V. The processing unit 23 can be a data processing device, such as a micro processor, a digital signal processor, or a computer. The processing unit 23 receives the operation status, the measurement result of the power grid, and the data inputted by a user through the carrier unit 21, the measuring unit 22, and the input unit 24. The processing unit 23 produces the control command through a management program. The control command is sent through the carrier unit 21 and the transmission medium 1 to the control module 3. The control command, the operation status, the measurement of the power grid, and the data inputted by the user can be outputted to the output unit 25, such as a liquid crystal display (LCD) or the like.

The control module 3 can be a wire control module or wireless control module. The control module 3 includes circuits or devices for receiving and transmitting signals, controlling electric appliances, processing data, and input/output of data. The control module 3 is coupled to the transmission medium 1 and at least one controlled apparatus A for receiving the control command from the management module 2 or the user and outputs at least one control signal for controlling the controlled apparatus A, such as an air conditioner, a television, a stereo, a security apparatus that can be controlled wirelessly, or an illumination device, an electrical heating device, or a water pump that can be controlled through wires. In this embodiment, the control module 3 includes a first control module 3a in the form of a wireless control module and a second control module 3b in the form of a wire control module. The first control module 3a controls at least one wireless controlled apparatus. The second control module 3b controls at least one wire controlled apparatus. However, the present invention is not limited to this embodiment.

The first control module 3a includes a carrier unit 31, a processing unit 32, an input unit 33, a remote control unit 34a, and an output unit 35. The carrier unit 31 is coupled to the transmission medium 1. The processing unit 32 is electrically connected to the carrier unit 31, the input unit 33, the remote control unit 34a, and the output unit 35. The remote control unit 34a is coupled to at least one first controlled apparatus A1. In this embodiment, the first controlled apparatus A1 is in the form of an air conditioner. However, the present invention is not limited to this embodiment.

The second control module 3b includes a carrier unit 31′, a processing unit 32′, an input unit 33′, an electrical control unit 34b, and an output unit 35′. The carrier unit 31′ is coupled to the transmission medium 1. The processing unit 32′ is electrically connected to the carrier unit 31′, the input unit 33′, the electrical control unit 34b, and the output unit 35′. The electrical control unit 34b is coupled to at least one second controlled apparatus A2. In this embodiment, the second controlled apparatus A2 is in the form of an illumination device. However, the present invention is not limited to this embodiment.

The carrier units 31 and 31′ are substantially the same as the carrier unit 21 of the management module 2. Each carrier unit 31, 31′ transmits the operation status of the control module 3 to the transmission medium 1 and allows the transmission medium 1 to receive the control command from the management module 2.

The processing units 32 and 32′ are substantially the same as the processing unit 23 of the management module 2. The processing unit 32 receives the control command through the carrier unit 31 and the input unit 33 (such as a keyboard and its decoder). Upon reception of the control command, at least one first control signal is produced through a first control program. A remote control signal corresponding to the first control signal is sent through the remote control unit 34a (such as an infrared remote control or a Zigbee short-distance wireless transceiver) to the first controlled apparatus A1. Thus, the first controlled apparatus A1 can be controlled by the management module 2 or the input of the user. Likewise, the processing unit 32′ receives the control command through the carrier unit 31′ and the input unit 33′ (such as a keyboard and its decoder). Upon reception of the control command, at least one second control signal is produced by a second control program. A remote control signal corresponding to the second control signal is sent through the electrical control unit 34b (such as a solid relay or a power control switch) to the second controlled apparatus A2. Thus, the second controlled apparatus A2 can be controlled by the management module 2 or the input of the user. Furthermore, the control command, the operation status, or the first control signal can be outputted to the output unit 35 (such as an LCD). Further, the control command, the operation status, or the second control signal can be outputted to the output unit 35′.

In use of the embodiment of the power usage control system according to the present invention, the management module 2 can monitor the operation status (such as the switch status, setting of temperature, etc.) of the first control module 3a (i.e., the wireless control module) and the second control module 3b (i.e., the wire control module) through the transmission medium 1. The measuring unit 22 of the management module 2 detects the power usage data of the above apparatuses, such as voltage, current, or power. The management program of the management module 2 compares the power usage data with the preset operation thresholds. The first and second control modules 3a and 3b can be controlled based on the comparison result, such as turning on/off the apparatuses, adjusting the set temperature, etc.

On the other hand, the first and second control modules 3a and 3b can capture the control command of the management module 2 through the transmission medium 1 and can detect whether the user has inputted control data (such as manual adjustment or changing some of the parameters of the apparatuses). The first or second controlled apparatus A1, A2 is controlled according to the control command or control data. Parameters, such as the consumed current or power, are displayed to provide reference for the user for the purposes of local manual control.

The management program of the management module 2 can be set to include at least one operation threshold, such as a voltage threshold, current threshold, or contract capacity between an enterprise and a power company. For example, the operation threshold is set to be 1.5 amperes. In a case that the actual operation value (the total consumed current) of the first and second controlled apparatuses A1 and A2 is 1.8 amperes, the management program undergoes a load management procedure. Specifically, after an unloading time (about 15 seconds), a control command is sent to the first and second control modules 3a and 3b to shut down a portion or all of the first and/or second controlled apparatuses A1 and A2. After the total consumed current is lower than the current threshold, the apparatus that was shut down can be automatically turned on by the management module 2 or manually turned on. Communication between the management module 2 and the first control module 3a or the second control module 3b will be set forth hereinafter.

Taking the communication between the management module 2 and the second control module 3b as an example, the communication format between the management module 2 and the second control module 3b is expressed in expression (1):

{T, F, M, D1, D2, D3, D4, D5} (1)

wherein each column is a character.

T is a destination module receiving the data. As an example, the control module 2, the first control module 3a, and the second control module 3b are respectively represented by characters “a”, “b”, and “c”. M is a communication command. As an example, “inquire” is represented by character “a”, “reply” is represented by character “q”, “control” is represented by character “c”, “temperature increased by 1□” is represented by character “u”, and “temperature decreased by 1□” is represented by character “d”. {D1, D2, D3, D4, D5} is communication data of five characters. As an example, {1, 0, 0, 0, 0} and {0, 0, 0, 0, 0} respectively represent operation and stop of the air conditioner. Alternatively, {D1, 1, 0, 0, 0} {D1, 0, 0, 0, 0} respectively represent an illumination device D1 is ON or OFF. The code number D1 of the illumination device can be replaced by 1, 2, 3, 4 or any desirable character.

When it is desired to know the operation status of the second controlled apparatus A2 (such as an illumination device), the management module 2 can transmit the control command to the transmission medium 1 in a serial manner, wherein the control command is expressed by expression (2):

{c, a, a, 0, 0, 0, 0, 0} (2)

After the first and second control modules 3a and 3b receive the control command, the first character is judged to determine whether it is the identification code. If yes, the source module, communication command, and the communication data are judged in sequence. If not, the control command is ignored. Thus, after the second control module 3b receives the control command of expression (2), a reply data expressed by expression (3) is sent to the transmission medium 1:

{a, c, q, 0, 0, 0, 0, 0} (3)

When the management module 2 receives the replay data, it is known that the second controlled apparatus A2 controlled by the second control module 3b is in an OFF status. At this time, if the actual operation value of the first and second controlled apparatuses A1 and A2 is still lower than the operation threshold, the management module 2 can turn on an illumination device (whose code number is 1) of the second controlled apparatus A2 according to the prosecution procedure of the management program. Another control command expressed by expression (4) is sent to the transmission medium 1:

{c, a, c, 1, 1, 0, 0, 0} (4)

After the second controlled apparatus A2 receives the control command of expression (4), a second control signal is sent to the second control apparatus A2 to turn on the illumination device whose code number is 1. At the same time, a reply data expressed by expression (5) is sent to the transmission medium 1:

{a, c, q, 1, 0, 0, 0, 0} (5)

Thus, the management module 2 knows the operation status of the second controlled apparatus A2.

In view of the foregoing, the main features of the power usage control system according to the present invention are that the management module 2 monitors the operation statuses of the first control module 3a (the wireless control module) and the second control module 3b (the wire control module) through the transmission medium 1, such as the switch status, setting of temperature, etc. Furthermore, the power usage data, such as, voltage, current, and power can be detected by the measuring unit 22. Thus, the management module 2 can compare the power usage data with the preset operation threshold and use the comparison result to control the first and second control modules 3a and 3b, such as turning on/off the apparatuses using power and adjusting the set temperature.

When the power usage is too high, the management module 2 sends a control command to the first and second control modules 3 and 3b to shut down the first and second controlled apparatuses A1 and A2 for reducing the power usage. After the total power usage is reduced, the management module 2 or the user adjusts the status of the first and second controlled apparatuses A1 and A2.

Thus, the management module 2 of the power usage control system according to the present invention can automatically monitor/control the power usage of the first and second controlled apparatuses A1 and A2 through the transmission medium 1 and the first and second control modules 3a and 3b while allowing the user to manually control the first and second control modules 3a and 3b to proceed with local adjustment of the first and second controlled apparatuses A1 and A2, fulfilling various power usage needs in various environments while saving manpower and managing power usage of loads.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A power usage control system comprising:
a transmission medium for transmitting power;
a management module coupled to the transmission medium; and
a control module coupled to the transmission medium and at least one controlled apparatus,
wherein the management module and the control module communicate with each other through the transmission medium, the management module monitors an operation status of the at least one controlled apparatus through the control module, the management module controls the at least one controlled apparatus through the control module.

2. The power usage control system as claimed in claim 1, wherein the transmission medium is a power line.

3. The power usage control system as claimed in claim 1, wherein the at least one controlled apparatus is a wireless controlled apparatus.

4. The power usage control system as claimed in claim 1, with the at least one controlled apparatus is a wire controlled apparatus.

5. The power usage control system as claimed in claim 1, with the management module including a carrier unit, a measuring unit, a processing unit, an input unit, and an output unit, with the carrier unit and the measuring unit coupled to the transmission medium, with the processing unit electrically connected to the carrier unit, the measuring unit, the input unit, and the output unit.

6. The power usage control system as claimed in claim 1, with the control module including a first control module, with the first control module including a carrier unit, a processing unit, an input unit, a remote control unit, and an output unit, with the carrier unit coupled to the transmission medium, with the processing unit electrically connected to the carrier unit, the input unit, the remote control unit, and the output unit, with the remote control unit coupled to a first controlled apparatus of the at least one controlled apparatus.

7. The power usage control system as claimed in claim 6, with the control module further including a second control module, with the second control module including a carrier unit, a processing unit, an input unit, an electrical control unit, and an output unit, with the carrier unit of the second control module coupled to the transmission medium, with the processing unit of the second control module electrically connected to the carrier unit, the input unit, the electrical control unit, and the output unit of the second control module, with the electrical control unit coupled to a second controlled apparatus of the at least one controlled apparatus.

8. The power usage control system as claimed in claim 6, wherein the first controlled apparatus is an air conditioner, a television, a stereo, or a security apparatus.

9. The power usage control system as claimed in claim 1, with the control module including a wire control module, with the wire control module including a carrier unit, a processing unit, an input unit, an electrical control unit, and an output unit, with the carrier unit of the wire control module coupled to the transmission medium, with the processing unit of the wire control module electrically connected to the carrier unit, the input unit, the electrical control unit, and the output unit of the wire control module, with the electrical control unit coupled to a wire controlled apparatus of the at least one controlled apparatus.

10. The power usage control system as claimed in claim 7, wherein the second controlled apparatus is an illumination device, an electrical heating device, or a water pump.

11. The power usage control system as claimed in claim 9, wherein the wire controlled apparatus is an illumination device, an electrical heating device, or a water pump.

12. The power usage control system as claimed in claim 1, with the management module including a management program, with the management program producing at least one control command to control the control module.

13. The power usage control system as claimed in claim 12, with the management program including at least one operation threshold, with the management program undergoing a load management procedure when an actual operation value of the at least one controlled apparatus is higher than the at least one operation threshold, with the control command sent to the control module to shut down a portion or all of the at least one controlled apparatus after an unloading time.
